(19) United States
(12) Patent Application Publication
(10) Pub. No.: US 2026/0171465 A1
(43) Pub. Date: Jun. 18, 2026

(54) BATTERY CELL AND BATTERY ASSEMBLY COMPRISING THE SAME

(71) Applicant: SK On Co., Ltd., Seoul (KR)

(72) Inventor: Ye Rin SEO, Daejeon (KR)

(21) Appl. No.: 19/424,123

(22) Filed: Dec. 18, 2025

(30) Foreign Application Priority Data
Dec. 18, 2024 (KR) 10-2024-0189896

(51) Int. Cl. H01M 10/04; H01M 10/613; H01M 10/647; H01M 10/659; H01M 50/105; H01M 50/178; H01M 50/54

(52) U.S. Cl. CPC H01M 10/0468; H01M 10/613; H01M 10/647; H01M 10/659; H01M 50/105; H01M 50/178; H01M 50/54

(57) ABSTRACT

The present disclosure relates to a battery cell and a battery assembly including the same. The battery cell may include: an electrode assembly in which a plurality of positive electrodes and a plurality of negative electrodes are alternately stacked with a separator interposed therebetween along a predetermined direction; a positive electrode tab which is electrically connected to the plurality of positive electrodes at one end of a length direction perpendicular to the predetermined direction of the electrode assembly; a negative electrode tab which is electrically connected to the plurality of negative electrodes at the other end of the length direction of the electrode assembly; a pouch which accommodates the electrode assembly therein and exposes at least a portion of the positive electrode tab and at least a portion of the negative electrode tab to an outside; and a pressing pad coupled to one surface of the pouch.

### CROSS-REFERENCE TO RELATED PATENT APPLICATION

The present application claims priority under 35 U.S.C. § 119(a) to Korean patent application number 10-2024-0189896 filed on Dec. 18, 2024, in the Ministry of Intellectual Property, the entire disclosure of which is incorporated by reference herein.

### BACKGROUND OF THE INVENTION

### 1. Field

The present disclosure relates to a battery cell and a battery assembly including the same, and more particularly, to a battery cell to which a pressing pad is attached and a battery assembly including the same.

### 2. Description of the Related Art

In a pouch-type battery cell, a pouch is configured to surround an electrode assembly including a positive electrode, a negative electrode, and a separator, and the electrode assembly accommodated in the pouch becomes non-uniform in thickness and has a thickness deviation due to a manufacturing method of the electrode assembly, a stacking method of a positive electrode plate and a negative electrode plate, and the like.

Specifically, the electrode assembly has a small thickness deviation in a portion located within a predetermined distance from the center of the electrode assembly, but has a large thickness deviation as being farther from the center of the electrode assembly in a portion located from a portion located at a predetermined distance from the center of the electrode assembly to a portion located at a distance greater than the predetermined distance from the center of the electrode assembly.

When the electrode assembly has such a thickness deviation, if a force is applied to one surface of the pouch surrounding the electrode assembly, a portion adjacent to a positive electrode tab and a negative electrode tab, which is located far from the center of the electrode assembly among the one surface of the pouch, may be pressed by a relatively small force.

As such, when a portion adjacent to the positive electrode tab and the negative electrode tab among the one surface of the pouch is pressed by a relatively small force, an interface between the positive electrode and the negative electrode and the separator may be joined non-uniformly, and an electrolyte may be distributed non-uniformly at the interface between the positive electrode and the negative electrode and the separator.

Accordingly, a moving direction of lithium ions moving through an electrolyte may be biased, and when the lithium ions are biased and move to the negative electrode, lithium ions that are concentrated in a portion of the negative electrode may be deposited as lithium metal on a surface of the negative electrode due to lithium ions that have not moved into the inside of the negative electrode.

Meanwhile, when a temperature of the battery cell becomes high, an electrical resistance of a predetermined portion of the positive electrode or the negative electrode becomes small, so that the movement of the lithium ions may be biased, and accordingly, the lithium ions may be deposited as lithium metal on the surface of the negative electrode.

When lithium metal is deposited on the surface of the negative electrode, there is a problem in that a capacity of the battery cell is reduced and a lifespan thereof becomes short.

In addition, lithium deposited as metal may electrically connect the positive electrode and the negative electrode, so that an internal short circuit may occur and a fire may occur in the battery cell.

Therefore, it is necessary to develop a battery cell in which one surface of the pouch can be pressed by a force having a uniform magnitude and can be effectively dissipated in heat, and a battery assembly including the same, so that an amount of lithium metal deposited on the negative electrode can be reduced.

### SUMMARY OF THE INVENTION

An object of the present disclosure is to provide a battery cell capable of reducing an amount of lithium metal deposited on a negative electrode.

Another object of the present disclosure is to provide a battery assembly including a battery cell capable of reducing an amount of lithium metal deposited on a negative electrode.

The battery cell of the present disclosure and the battery assembly including the same may be widely used in green technology fields using batteries, such as electric vehicles. In addition, the battery cell of the present disclosure and the battery assembly including the same may be used in eco-friendly electric vehicles, hybrid vehicles, and the like, for preventing climate change by suppressing air pollution and greenhouse gas emissions.

As a technical means for solving the above-described technical tasks, a battery cell according to an embodiment of the present disclosure may include: an electrode assembly in which a plurality of positive electrodes and a plurality of negative electrodes are alternately stacked with a separator interposed therebetween along a predetermined direction; a positive electrode tab which is electrically connected to the plurality of positive electrodes at one end of a length direction perpendicular to the predetermined direction of the electrode assembly; a negative electrode tab which is electrically connected to the plurality of negative electrodes at the other end of the length direction of the electrode assembly; a pouch which accommodates the electrode assembly therein and exposes at least a portion of the positive electrode tab and at least a portion of the negative electrode tab to an outside; and a pressing pad coupled to one surface of the pouch perpendicular to the predetermined direction, and the pressing pad may be formed such that a thickness, which is a length in the direction perpendicular to the one surface, varies according to a distance spaced apart from the positive electrode tab and a distance spaced apart from the negative electrode tab.

In addition, the pressing pad may be formed such that a first thickness, which is a thickness of a first portion adjacent to the positive electrode tab, and a second thickness, which is a thickness of a second portion adjacent to the negative electrode tab, are thicker than a third thickness, which is a thickness of a third portion other than the first portion and the second portion.

In addition, the positive electrode tab may be located at one end of the length direction of the one surface, and the negative electrode tab may be located at the other end of the length direction of the one surface, and the pressing pad may be formed to extend in the length direction, and may be formed to cover between the one end of the length direction of the one surface and the other end of the length direction of the one surface.

In addition, the first portion may be disposed between one end of the length direction of the pressing pad and a position spaced apart by a first length from the one end of the length direction of the pressing pad toward the other end of the length direction of the pressing pad, and the second portion may be disposed between the other end of the length direction of the pressing pad and a position spaced apart by a second length from the other end of the length direction of the pressing pad toward the one end of the length direction of the pressing pad.

In addition, the first portion, the second portion, and the third portion may be formed such that the thickness is constant respectively.

In addition, the first portion may include a first cooling member that absorbs heat released from the one surface, and the second portion may include a second cooling member that absorbs heat released from the one surface.

In addition, the first cooling member may be formed to have a constant thickness and may be disposed in the first portion so as to face the one surface, and the second cooling member may be formed to have a constant thickness and may be disposed in the second portion so as to face the one surface.

In addition, the first cooling member may be disposed in the first portion such that a distance between the first cooling member and the one surface becomes farthest, and the second cooling member may be disposed in the second portion such that a distance between the second cooling member and the one surface becomes farthest.

In addition, the pressing pad may include rubber, and the first cooling member and the second cooling member may include paraffin.

In addition, the first thickness of the first portion and the second thickness of the second portion may be the same, and the first length of the first portion and the second length of the second portion may be the same.

In addition, the first thickness and the second thickness may be 1.5 times or more and 3 times or less than the third thickness, and the first length and the second length may be 0.25 times or more and 0.375 times or less of the length in the length direction of the pressing pad.

As a technical means for solving the above-described technical tasks, a battery assembly according to an embodiment of the present disclosure may include: a case forming a receiving space therein; and a cell assembly accommodated in the receiving space and formed by stacking a plurality of battery cells, and the battery cell may be the battery cell according to an embodiment of the present disclosure.

In addition, in the battery cell, the first thickness of the first portion and the second thickness of the second portion may be the same, and the first length of the first portion and the second length of the second portion may be the same.

In addition, the first thickness and the second thickness may be 1.5 times or more and 3 times or less than the third thickness, and the first length and the second length may be 0.25 times or more and 0.375 times or less of a distance between the positive electrode tab and the negative electrode tab.

Specific details of other embodiments for solving the tasks are included in the description of the invention and the drawings.

According to the means for solving the tasks of the present disclosure described above, the battery cell according to the present disclosure and the battery assembly including the same provide an effect in that one surface of the pouch of the battery cell can be pressed by a force having a uniform magnitude, thereby reducing an amount of lithium metal deposited on a negative electrode of the battery cell.

In addition, since one surface of the pouch of the battery cell can be effectively dissipated in heat, an effect of reducing an amount of lithium metal deposited on the negative electrode of the battery cell is provided.

### BRIEF DESCRIPTION OF THE DRAWINGS

FIG. 1 is a cross-sectional view illustrating a battery cell according to an embodiment of the present disclosure.

FIG. 2 is a perspective view of the battery cell.

FIG. 3 is a perspective view of the pressing pad.

FIG. 4 is a view illustrating an example of the pressing pad including a cooling member.

FIG. 5 is a view illustrating another example of the pressing pad including a cooling member.

FIG. 6 is a side view of the pressing pad.

FIG. 7 is a graph illustrating a capacity retention of the battery cell and an expansion rate of the battery cell according to thicknesses of respective portions of the pressing pad.

FIG. 8 is a graph illustrating a capacity retention of the battery cell and an expansion rate of the battery cell according to lengths of respective portions of the pressing pad.

FIG. 9 is an exploded perspective view of a battery assembly according to an embodiment of the present disclosure.

### DETAILED DESCRIPTION

Hereinafter, embodiments of the present application will be described in detail with reference to the accompanying drawings so that those skilled in the art to which the present application pertains can easily carry out the present application. However, the present application may be implemented in various different forms and is not limited to the embodiments described herein. In the drawings, parts irrelevant to the description are omitted for clearly describing the present application, and like reference numerals refer to like elements throughout the specification.

Throughout the specification of the present application, when a part is described as being “connected” to another part, it includes not only a case where the part is “directly connected” but also a case where the part is “electrically connected” with another element interposed therebetween.

Throughout the specification of the present application, when a member is described as being “on” another member, it includes not only a case where the member is in contact with the other member but also a case where another member is present between the two members.

Throughout the specification of the present application, when a part “includes” a component, it means that the part may further include another component unless specifically stated otherwise, rather than excluding the other component. The degree terms such as “about” and “substantially” used throughout the specification of the present application are used in a sense close to the numerical value when inherent manufacturing and material tolerances for the stated meaning are presented, and are used to prevent an unscrupulous infringer from unfairly taking advantage of the disclosed content in which precise or absolute numerical values are mentioned for ease of understanding of the present application. The degree terms “˜step” or “step of ˜” used throughout the specification of the present application do not mean “a step for ˜”.

Hereinafter, preferred embodiments of the present disclosure will be described in detail with reference to the accompanying drawings and the content described below. However, the present disclosure is not limited to the embodiments described herein and may be embodied in other forms. Throughout the specification, like reference numerals refer to like components.

Hereinafter, a battery cell according to an embodiment of the present disclosure will be described.

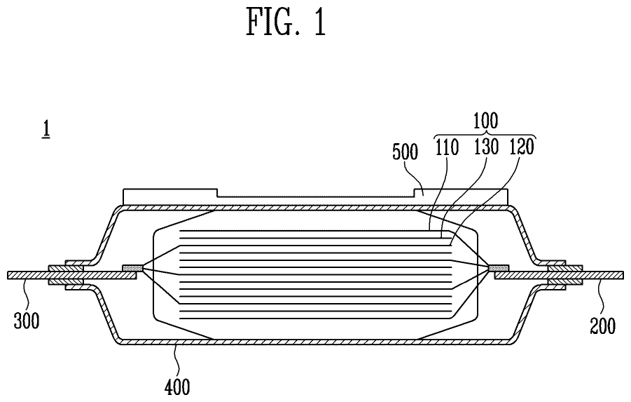

FIG. 1 is a cross-sectional view illustrating a battery cell according to an embodiment of the present disclosure.

Referring to FIG. 1, a battery cell 1 includes an electrode assembly 100, a positive electrode tab 200, a negative electrode tab 300, a pouch 400, and a pressing pad 500.

First, the electrode assembly 100 will be described.

As illustrated in FIG. 1, the electrode assembly 100 may be formed by alternately stacking a plurality of positive electrodes 110 and a plurality of negative electrodes 120 with a separator 130 interposed therebetween along a predetermined direction.

The positive electrode 110 may be formed by applying a positive electrode active material such as a transition metal oxide to a positive electrode current collector formed of a metal foil such as aluminum.

In addition, the positive electrode 110 includes a positive electrode non-coated portion which is a region where the positive electrode active material is not applied, and the positive electrode non-coated portion may serve as a passage for current flow between the positive electrode 110 and an outside.

The negative electrode 120 may be formed by applying a negative electrode active material such as graphite or carbon to a negative electrode current collector formed of a metal foil such as copper or nickel.

In addition, the negative electrode 120 includes a negative electrode non-coated portion which is a region where the negative electrode active material is not applied, and the negative electrode non-coated portion may serve as a passage for current flow between the negative electrode 120 and an outside.

The separator 130 is located between the positive electrode 110 and the negative electrode 120 to prevent a short circuit and to allow movement of lithium ions. Such a separator may be formed of polyethylene, polypropylene, or a composite film of polyethylene and polypropylene.

The plurality of positive electrodes 110 and the plurality of negative electrodes 120 formed as described above may be alternately stacked with the separator 130 interposed therebetween to form the electrode assembly 100, and as illustrated in FIG. 1, the electrode assembly 100 may be accommodated in the pouch 400.

Next, the positive electrode tab 200 will be described.

As illustrated in FIG. 1, the positive electrode tab 200 may be electrically connected to the plurality of positive electrodes 110 at one end of a length direction (hereinafter, referred to as a length direction) perpendicular to a predetermined direction of the electrode assembly 100.

Specifically, the positive electrode tab 200 may be electrically connected to the positive electrode 110 by a member capable of conducting electricity being connected to the plurality of positive electrode non-coated portions, or may be formed by the plurality of positive electrode non-coated portions.

Next, the negative electrode tab 300 will be described.

As illustrated in FIG. 1, the negative electrode tab 300 may be electrically connected to the plurality of negative electrodes 120 at the other end of the length direction of the electrode assembly 100.

Specifically, the negative electrode tab 300 may be electrically connected to the negative electrode 120 by a member capable of conducting electricity being connected to the plurality of negative electrode non-coated portions, or may be formed by the plurality of negative electrode non-coated portions.

Next, the pouch 400 will be described.

As illustrated in FIG. 1, the pouch 400 accommodates the electrode assembly 100 therein and may expose at least a portion of the positive electrode tab 200 and at least a portion of the negative electrode tab 300 to an outside.

At this time, the positive electrode tab 200 may be located adjacent to one end of the length direction of one surface of the pouch 400, and the negative electrode tab 300 may be located adjacent to the other end of the length direction of the one surface of the pouch 400.

Such a pouch 400 may be formed of an insulating member made of a flexible material, but the configuration of the pouch 400 is not limited thereto.

Next, the pressing pad 500 will be described.

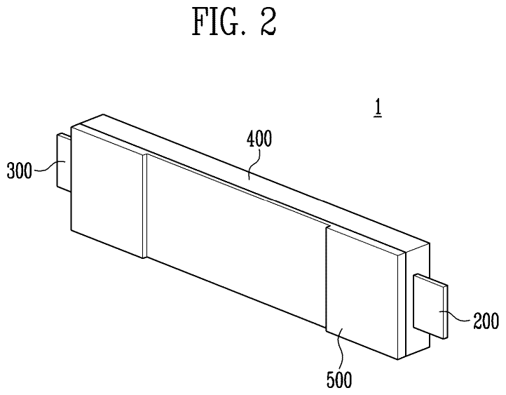

FIG. 2 is a perspective view of the battery cell.

Referring to FIGS. 1 and 2, the pressing pad 500 may be coupled to one surface of the pouch 400 perpendicular to a predetermined direction.

Specifically, the pressing pad 500 may be formed to extend in the length direction and may be coupled to the one surface of the pouch 400 by being formed to cover between one end of the length direction of the one surface of the pouch 400 and the other end of the length direction of the one surface of the pouch 400.

For example, the pressing pad 500 may be formed to cover an entire one surface of the pouch 400 and may be coupled to the one surface of the pouch 400, and may be formed to include rubber, but the configuration of the pressing pad 500 is not limited thereto.

When the plurality of battery cells 1 are arranged such that the one surface of the pouch 400 is pressed by one another, such a pressing pad 500 may perform a function of allowing a force having a uniform magnitude to act on the one surface of the pouch 400, and may be formed such that a thickness, which is a length in the direction perpendicular to the one surface of the pouch 400, varies according to a distance spaced apart from the positive electrode tab 200 and a distance spaced apart from the negative electrode tab 300.

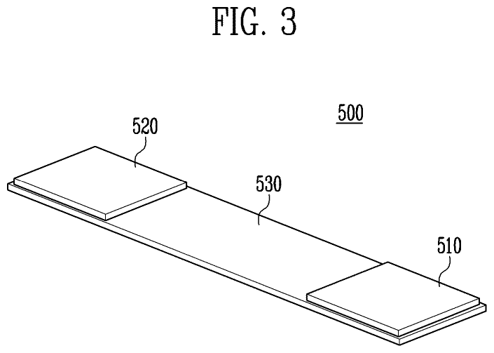

FIG. 3 is a perspective view of the pressing pad.

For example, referring to FIG. 3, the pressing pad 500 may include a first portion 510 that becomes adjacent to the positive electrode tab 200, a second portion 520 that becomes adjacent to the negative electrode tab 300, and a third portion 530 which is a portion other than the first portion 510 and the second portion 520.

At this time, the pressing pad 500 may be configured such that the first portion 510, the second portion 520, and the third portion 530 are integrally formed, or may be configured such that predetermined members are coupled to one end and the other end in the length direction of the third portion 530 extending in the length direction to form the first portion 510 and the second portion 520.

In addition, a first thickness T1, which is a thickness of the first portion 510, and a second thickness T2, which is a thickness of the second portion 520, may be formed to be thicker than a third thickness T3, which is a thickness of the third portion 530.

When the first portion 510 and the second portion 520 of the pressing pad 500 are formed to be thicker than the third portion 530 as described above, one surface of the pouch 400 surrounding the electrode assembly 100, in which a portion adjacent to the positive electrode tab 200 and the negative electrode tab 300 becomes thinner than a central thickness, may be pressed by a force having a uniform magnitude at respective positions.

At this time, the first portion 510, the second portion 520, and the third portion 530 may be formed such that the thickness is constant respectively.

Meanwhile, the pressing pad 500 may be configured to effectively dissipate heat generated from the battery cell 1.

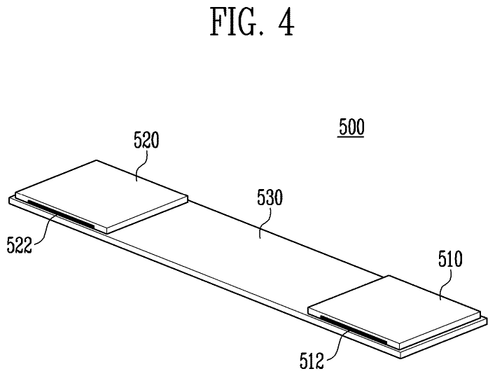

FIG. 4 is a view illustrating an example of the pressing pad including a cooling member.

Specifically, referring to FIG. 4, the first portion 510 of the pressing pad 500 may include a first cooling member 512 that absorbs heat released from the one surface of the pouch 400, and the second portion 520 may include a second cooling member 522 that absorbs heat released from the one surface of the pouch 400.

The first cooling member 512 and the second cooling member 522 may be formed of a material having relatively large latent heat and being chemically stable.

For example, the first cooling member 512 and the second cooling member 522 may be formed to include paraffin. When the first cooling member 512 and the second cooling member 522 are formed to include paraffin, they may be easily attached to the pressing pad 500 formed of rubber, and the first cooling member 512 and the second cooling member 522 may be manufactured at a relatively low cost.

The first cooling member 512 and the second cooling member 522 may be respectively disposed in the first portion 510 and the second portion 520 in various structures.

For example, as illustrated in FIG. 4, the first cooling member 512 may be formed to have a constant thickness and may be disposed in the first portion 510 so as to face the one surface of the pouch 400, and the second cooling member 522 may be formed to have a constant thickness and may be disposed in the second portion 520 so as to face the one surface of the pouch 400.

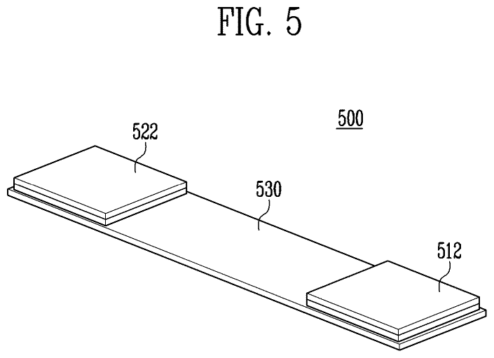

FIG. 5 is a view illustrating another example of the pressing pad including a cooling member.

In another example, as illustrated in FIG. 5, the first cooling member 512 may be disposed in the first portion 510 such that a distance between the first cooling member 512 and the one surface of the pouch 400 becomes farthest, and the second cooling member 522 may be disposed in the second portion 520 such that a distance between the second cooling member 522 and the one surface of the pouch 400 becomes farthest.

That is, the first cooling member 512 may be located on a surface of the first portion 510, and the second cooling member 522 may be located on a surface of the second portion 520.

As such, by the first portion 510 including the first cooling member 512 and the second portion 520 including the second cooling member 522, a portion adjacent to the positive electrode tab 200 and the negative electrode tab 300 of the battery cell 1 may be effectively dissipated in heat, and an increase in temperature of a portion adjacent to the positive electrode tab 200 and the negative electrode tab 300 of the positive electrode 110 and the negative electrode 120, which causes an electrical resistance to become small and movement of lithium ions to be biased, may be prevented.

Therefore, it is possible to prevent lithium ions from being concentrated in a predetermined portion of the negative electrode 120, and to effectively reduce an amount of lithium ions that are not moved into the inside of the negative electrode 120 and are deposited as metal on a surface of the negative electrode 120.

Meanwhile, the first portion 510 and the second portion 520 of the pressing pad 500 may be formed to more effectively prevent a performance degradation of the battery cell 1 and to more effectively prevent the battery cell 1 from expanding.

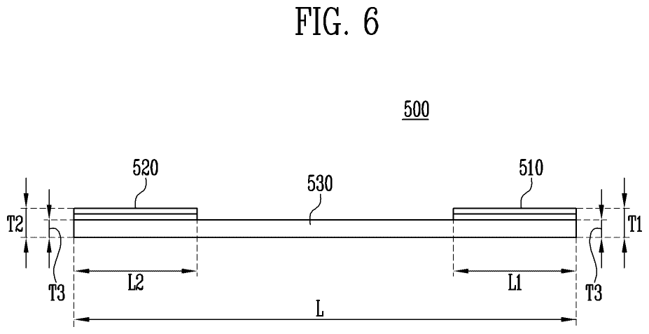

FIG. 6 is a side view of the pressing pad.

Specifically, as illustrated in FIG. 6, the first portion 510 may be disposed between one end of the length direction of the pressing pad 500 and a position spaced apart by a first length L1 from the one end of the length direction of the pressing pad 500 toward the other end of the length direction of the pressing pad 500.

In addition, the second portion 520 may be disposed between the other end of the length direction of the pressing pad 500 and a position spaced apart by a second length L2 from the other end of the length direction of the pressing pad 500 toward the one end of the length direction of the pressing pad 500.

At this time, the first thickness T1 of the first portion 510 and the second thickness T2 of the second portion 520 may be the same, and the first length L1 of the first portion 510 and the second length L2 of the second portion 520 may be the same.

In addition, the first thickness T1 of the first portion 510 and the second thickness T2 of the second portion 520 may be 1.5 times or more and 3 times or less than the third thickness T3 of the third portion 530, and the first length L1 of the first portion 510 and the second length L2 of the second portion 520 may be 0.25 times or more and 0.375 times or less of the length L in the length direction of the pressing pad 500.

When the first portion 510 and the second portion 520 are formed as described above, the battery cell 1 to which the pressing pad 500 is coupled may be prevented from having performance degradation and may be prevented from expanding.

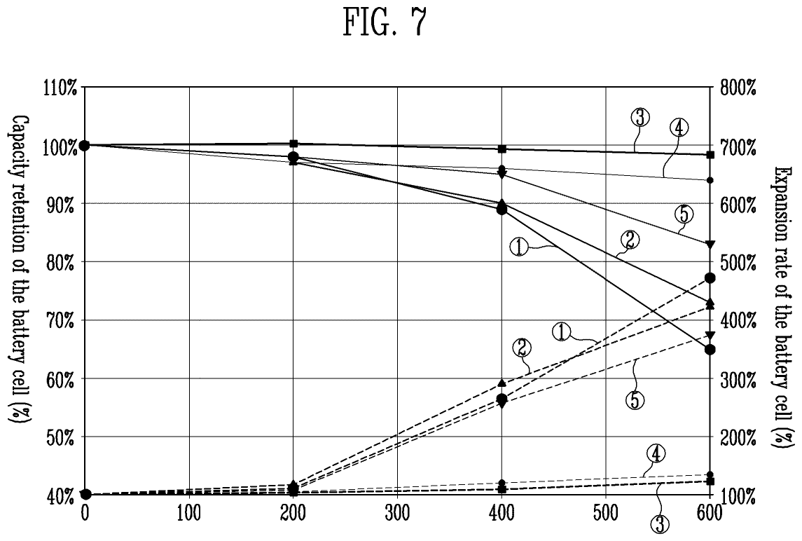

FIG. 7 is a graph illustrating a capacity retention of the battery cell and an expansion rate of the battery cell according to thicknesses of respective portions of the pressing pad.

Specifically, referring to FIG. 7, a graph indicated by a solid line among the graphs of FIG. 7 illustrates a capacity retention (%) of the battery cell according to the thicknesses of the first portion 510 and the second portion 520 of the pressing pad 500, and a graph indicated by a dotted line illustrates an expansion rate (%) of the battery cell according to the thicknesses of the first portion 510 and the second portion 520 of the pressing pad 500.

In addition, a graph \textcircled{1} is a graph when the thicknesses of the first portion 510 and the second portion 520 are the same as the thickness of the third portion 530, a graph \textcircled{2} is a graph when the thicknesses of the first portion 510 and the second portion 520 are 1.2 times the thickness of the third portion 530, a graph \textcircled{3} is a graph when the thicknesses of the first portion 510 and the second portion 520 are 1.5 times the thickness of the third portion 530, a graph \textcircled{4} is a graph when the thicknesses of the first portion 510 and the second portion 520 are 3 times the thickness of the third portion 530, and a graph \textcircled{5} is a graph when the thicknesses of the first portion 510 and the second portion 520 are 3.5 times the thickness of the third portion 530.

As illustrated in FIG. 7, when a pressing pad 500 in which the thicknesses of the first portion 510 and the second portion 520 are 1.5 times or 3 times the thickness of the third portion 530 is coupled to the battery cell 1, a rate of decrease in the capacity retention (%) of the battery cell as charging and discharging are repeated is smaller than when a pressing pad 500 in which the thicknesses of the first portion 510 and the second portion 520 are 1.2 times or 3.5 times the thickness of the third portion 530 is coupled to the battery cell 1.

In addition, as illustrated in FIG. 7, when a pressing pad 500 in which the thicknesses of the first portion 510 and the second portion 520 are 1.5 times or 3 times the thickness of the third portion 530 is coupled to the battery cell 1, a rate of increase in the expansion rate (%) of the battery cell as charging and discharging are repeated is smaller than when a pressing pad 500 in which the thicknesses of the first portion 510 and the second portion 520 are 1.2 times or 3.5 times the thickness of the third portion 530 is coupled to the battery cell 1.

That is, when a pressing pad 500 in which the thicknesses of the first portion 510 and the second portion 520 are 1.5 times or more and 3 times or less the thickness of the third portion 530 is coupled to the battery cell 1, even when charging and discharging of the battery cell 1 are repeated, the capacity retention (%) of the battery cell 1 decreases less and the expansion rate (%) of the battery cell 1 increases less, so that it can be seen that performance degradation of the battery cell 1 can be effectively prevented.

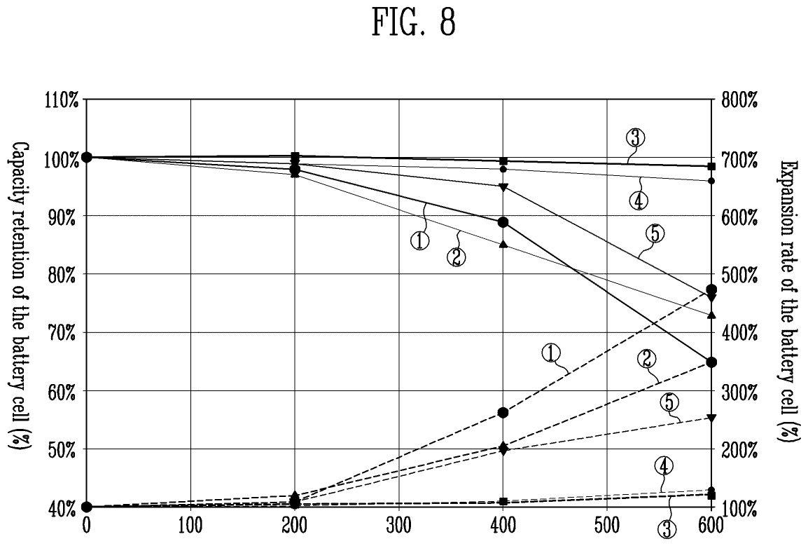

FIG. 8 is a graph illustrating a capacity retention of the battery cell and an expansion rate of the battery cell according to lengths of respective portions of the pressing pad.

In addition, referring to FIG. 8, a graph indicated by a solid line among the graphs of FIG. 8 illustrates a capacity retention (%) of the battery cell according to the lengths of the first portion 510 and the second portion 520 of the pressing pad 500, and a graph indicated by a dotted line illustrates an expansion rate (%) of the battery cell according to the lengths of the first portion 510 and the second portion 520 of the pressing pad 500.

In addition, a graph \textcircled{1} is a graph when the lengths of the first portion 510 and the second portion 520 are zero, a graph \textcircled{2} is a graph when the lengths of the first portion 510 and the second portion 520 are 0.125 times the length of the pressing pad 500, a graph \textcircled{3} is a graph when the lengths of the first portion 510 and the second portion 520 are 0.25 times the length of the pressing pad 500, a graph \textcircled{4} is a graph when the lengths of the first portion 510 and the second portion 520 are 0.375 times the length of the pressing pad 500, and a graph \textcircled{5} is a graph when the lengths of the first portion 510 and the second portion 520 are 0.5 times the length of the pressing pad 500.

As illustrated in FIG. 8, when a pressing pad 500 in which the lengths of the first portion 510 and the second portion 520 are 0.25 times or 0.375 times the length of the pressing pad 500 is coupled to the battery cell 1, a rate of decrease in the capacity retention (%) of the battery cell as charging and discharging are repeated is smaller than when a pressing pad 500 in which the lengths of the first portion 510 and the second portion 520 are 0.125 times or 0.5 times the length of the pressing pad 500 is coupled to the battery cell 1.

In addition, as illustrated in FIG. 8, when a pressing pad 500 in which the lengths of the first portion 510 and the second portion 520 are 0.25 times or 0.375 times the length of the pressing pad 500 is coupled to the battery cell 1, a rate of increase in the expansion rate (%) of the battery cell as charging and discharging are repeated is smaller than when a pressing pad 500 in which the lengths of the first portion 510 and the second portion 520 are 0.125 times or 0.5 times the length of the pressing pad 500 is coupled to the battery cell 1.

That is, when a pressing pad 500 in which the lengths of the first portion 510 and the second portion 520 are 0.25 times or more and 0.375 times or less the length of the pressing pad 500 is coupled to the battery cell 1, even when charging and discharging of the battery cell 1 are repeated, the capacity retention (%) of the battery cell 1 decreases less and the expansion rate (%) of the battery cell 1 increases less, so that it can be seen that performance degradation of the battery cell 1 can be effectively prevented.

Hereinafter, a battery assembly according to an embodiment of the present disclosure will be described.

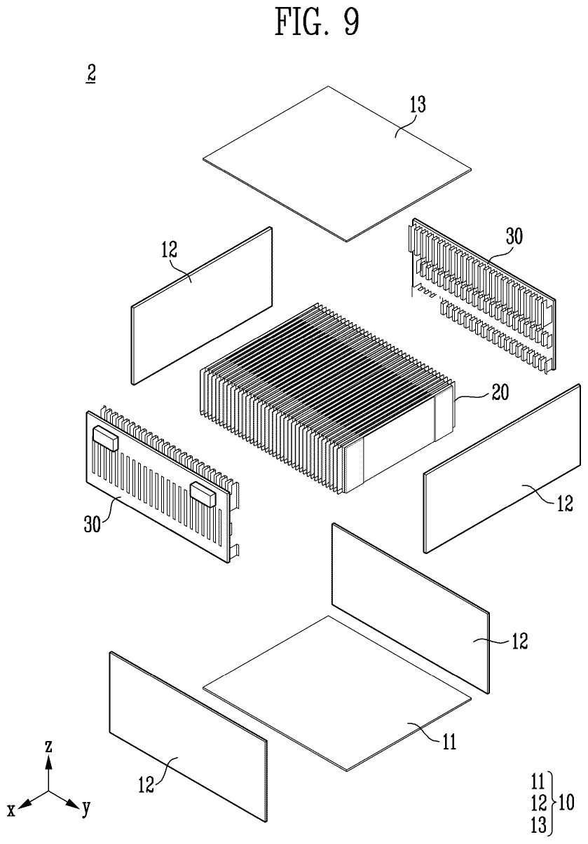

FIG. 9 is an exploded perspective view of a battery assembly according to an embodiment of the present disclosure.

Referring to FIG. 9, a battery assembly 2 may include a case 10, a cell assembly 20, and a busbar assembly 30.

First, the case 10 will be described.

The case 10 may form a receiving space therein.

Specifically, the case 10 may form an exterior of the battery assembly 2, and as illustrated in FIG. 9, may include a lower plate 11, a side plate 12 connected to the lower plate 11 to form the receiving space, and an upper plate 13 coupled to the side plate 12 to seal the receiving space.

Next, the cell assembly 20 will be described.

The cell assembly 20 may be accommodated in the receiving space and may be formed by stacking a plurality of battery cells 1.

Since the battery cell 1 included in the cell assembly 20 is the same as the battery cell 1 according to an embodiment of the present disclosure, a detailed description thereof will be omitted below.

Meanwhile, the plurality of battery cells 1 included in the cell assembly 20 may be stacked such that one surface of the pouch 400 to which the pressing pad 500 is coupled faces a battery cell 1 adjacent thereto.

Therefore, each of the battery cells 1 included in the cell assembly 20 may be pressed by a battery cell 1 adjacent thereto to which the pressing pad 500 is coupled, and one surface of the pouch 400 surrounding the electrode assembly 100 may be pressed by a force having a uniform magnitude at respective positions.

Next, the busbar assembly 30 will be described.

Referring to FIG. 9, the busbar assembly 30 may include at least one busbar configured to electrically interconnect the plurality of battery cells 1, and a busbar frame configured to mount the busbar on an outer side.

Such a busbar assembly 30 may be disposed in the receiving space and may be electrically connected to the plurality of battery cells 1. For example, the busbar assembly 30 may be accommodated in the receiving space by being disposed to face each other with the cell assembly 20 interposed therebetween so as to be electrically connected to the plurality of stacked battery cells 1.

As such, according to the means for solving the tasks of the present disclosure described above, the battery cell according to the present disclosure and the battery assembly including the same provide an effect in that one surface of the pouch of the battery cell can be pressed by a force having a uniform magnitude, thereby reducing an amount of lithium metal deposited on a negative electrode of the battery cell.

In addition, since one surface of the pouch of the battery cell can be effectively dissipated in heat, an effect of reducing an amount of lithium metal deposited on the negative electrode of the battery cell is provided.

The above description of the present disclosure is merely for illustrative purposes, and those skilled in the art to which the present disclosure pertains will understand that various modifications can be easily made without departing from the technical spirit or essential features of the present disclosure. Therefore, the embodiments described above are to be understood as illustrative and not restrictive in all respects. For example, each component described as being in a single form may be implemented in a dispersed form, and components described as being dispersed may likewise be implemented in a combined form.

The scope of the present disclosure is defined by the following claims rather than the foregoing detailed description, and all changes or modified forms derived from the meanings, the scope, and the equivalent concept of the claims are to be construed as being included in the scope of the present disclosure.

What is claimed is:

1. A battery cell comprising:
a plurality of positive electrodes and a plurality of negative electrodes which are alternately stacked with a separator interposed therebetween along a predetermined direction to form an electrode assembly;
a positive electrode tab which is electrically connected to the plurality of positive electrodes at one end of a length direction perpendicular to the predetermined direction of the electrode assembly;
a negative electrode tab which is electrically connected to the plurality of negative electrodes at the other end of the length direction of the electrode assembly;
a pouch which accommodates the electrode assembly therein and exposes at least a portion of the positive electrode tab and at least a portion of the negative electrode tab to an outside; and
a pressing pad coupled to one surface of the pouch perpendicular to the predetermined direction,
wherein the pressing pad is formed such that a thickness, which is a length in the direction perpendicular to the one surface of the pouch, varies according to a distance spaced apart from the positive electrode tab and a distance spaced apart from the negative electrode tab.

2. The battery cell according to claim 1, wherein the pressing pad is formed such that a first thickness, which is a thickness of a first portion adjacent to the positive electrode tab, and a second thickness, which is a thickness of a second portion adjacent to the negative electrode tab, are thicker than a third thickness, which is a thickness of a third portion other than the first portion and the second portion.

3. The battery cell according to claim 2, wherein the positive electrode tab is located adjacent to one end of the length direction of the one surface of the pouch, and the negative electrode tab is located adjacent to the other end of the length direction of the one surface of the pouch, and the pressing pad is formed to extend in the length direction and to cover between the one end of the length direction of the one surface of the pouch and the other end of the length direction of the one surface of the pouch.

4. The battery cell according to claim 3, wherein the first portion is disposed between one end of the length direction of the pressing pad and a position spaced apart by a first length from the one end of the length direction of the pressing pad toward the other end of the length direction of the pressing pad, and the second portion is disposed between the other end of the length direction of the pressing pad and a position spaced apart by a second length from the other end of the length direction of the pressing pad toward the one end of the length direction of the pressing pad.

5. The battery cell according to claim 4, wherein the first thickness of the first portion, the second thickness of the second portion, and the third thickness of the third portion are respectively formed to be constant.

6. The battery cell according to claim 5, wherein the first portion includes a first cooling member that absorbs heat released from the one surface of the pouch, and the second portion includes a second cooling member that absorbs heat released from the one surface of the pouch.

7. The battery cell according to claim 6, wherein the first cooling member is formed to have a constant thickness and is disposed in the first portion so as to face the one surface of the pouch, and the second cooling member is formed to have a constant thickness and is disposed in the second portion so as to face the one surface of the pouch.

8. The battery cell according to claim 7, wherein the first cooling member is disposed in the first portion such that a distance between the first cooling member and the one surface of the pouch becomes farthest, and the second cooling member is disposed in the second portion such that a distance between the second cooling member and the one surface of the pouch becomes farthest.

9. The battery cell according to claim 8, wherein the pressing pad includes rubber, and the first cooling member and the second cooling member respectively include paraffin.

10. The battery cell according to claim 5, wherein the first thickness of the first portion and the second thickness of the second portion are the same, and a first length of the first portion and a second length of the second portion are the same.

11. The battery cell according to claim 10, wherein the first thickness and the second thickness are 1.5 times or more and 3 times or less than the third thickness, and the first length and the second length are 0.25 times or more and 0.375 times or less of the length in the length direction of the pressing pad.

12. A battery assembly comprising:
a case forming a receiving space therein; and
a cell assembly accommodated in the receiving space and formed by stacking a plurality of battery cells,
wherein the battery cell is the battery cell according to claim 1.

13. The battery assembly according to claim 12, wherein, in the battery cell, the first thickness of the first portion and the second thickness of the second portion are the same, and a first length of the first portion and a second length of the second portion are the same.

14. The battery assembly according to claim 13, wherein the first thickness and the second thickness are 1.5 times or more and 3 times or less than the third thickness, and the first length and the second length are 0.25 times or more and 0.375 times or less of a distance between the positive electrode tab and the negative electrode tab.
